(19) United States
(12) Patent Application Publication
(10) Pub. No.: US 2019/0026684 A1
(43) Pub. Date: Jan. 24, 2019

(54) CONFIDENTIAL FOOD DELIVERY SYSTEM FOR SOCIAL SOFTWARE APPLICATIONS

(71) Applicants: David Martinez, Hollywood, FL (US); Denis Kreynin, Fort Lauderdale, FL (US)

(72) Inventors: David Martinez, Hollywood, FL (US); Denis Kreynin, Fort Lauderdale, FL (US)

(21) Appl. No.: 15/954,881

(22) Filed: Apr. 17, 2018

Related U.S. Application Data
(60) Provisional application No. 62/535,408, filed on Jul. 21, 2017.

(51) Int. Cl. G06Q 10/08; G06Q 50/12

(52) U.S. Cl. CPC G06Q 10/083; G06Q 50/12

(57) ABSTRACT

The present invention relates in general to a system and method for purchasing food from a restaurant to be prepared and sent as soon as possible to an undisclosed, designated location. The purchasing of the food occurs over the internet. This invention, more particularly, allows for the third-party purchasing of food delivery to another person without having to know that person's delivery address. More specifically, the system and method is designed to purchase food delivery for a person that is live-streaming on the internet, such as via Twitch.tv, Justin.tv, or YouTube. In one embodiment, the recipient cannot have food delivery purchased for them if they are not live-streaming, so as to prevent a delivery being sent when they are not available to receive it. In a second embodiment, the recipient may not need to be live-streaming to receive a delivery. Such a delivery may be called a “Treat” when using the present system and method.

### PRIORITY NOTICE

The present application is a non-provisional utility application and makes a claim of priority under 35 U.S.C. § 119(e) to prior provisional application 62/535,408 filed in the United States Patent and Trademark Office on Jul. 21, 2017.

### CROSS REFERENCE TO RELATED PATENT APPLICATIONS

The present application makes no reference to any other related filed patent applications.

### STATEMENT REGARDING FEDERAL SPONSORSHIP

No part of this invention was a result of any federally sponsored research.

### TECHNICAL FIELD OF THE INVENTION

The present invention relates in general to a system and method for purchasing food from a restaurant to be prepared and sent as soon as possible to an undisclosed, designated location. The purchasing of the food occurs over the internet. This invention, more particularly, allows for the third-party purchasing of food delivery to another person without having to know that person's delivery address.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

In today's society, purchasing food delivery online is very commonplace. There are many online services that let you purchase food delivery for yourself, or for others, as long as you supply the service with the proper delivery address before you checkout. However, these services do not allow for the purchasing of food delivery for someone other than yourself without needing to input any delivery address at all. Also, if you're choosing to order food delivery for someone else, there is no way for these services to know if the recipient is available to receive the food delivery, for it would cause an inconvenience for the restaurant to deliver food to an empty location.

It is known to have a live streaming video platform, such as Twitch.tv, Justin.tv, or YouTube, where users may live stream a plurality of media on their individual channels. Such media may focus on various categories of interests depending on the live streaming video platform, though all allow for individual channels to accumulate “subscribers,” “followers,” or the like. Such subscribers may receive updates and notifications from the manager of the individual channel, and most such channels are managed so as to be interactive with the plurality of subscribers. Such interactivity may include real-time interaction between the channel manager and the individual subscribers, and may also include allowing the individual subscribers to send gifts of money or items to the channel manager. Such gifts may specifically include monetary payments, purchasing of items, or purchasing of food, any of which may be sent directly to the manager of the channel. Such channel managers, though, may be unwilling to share personal identifying information, such as their bank account information or home address, generally with their subscribers, while still preferring to allow these subscribers to send them money and gifts.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a system and method for purchasing food from a restaurant to be prepared and sent as soon as possible to an undisclosed, designated location.

It is an objective of the present invention to provide a system and method that is a designed to purchase food delivery for a particular recipient, without the purchaser knowing the recipient's delivery address. In more specific terms, the system and method is designed to purchase food delivery for a person that may be live-streaming on the internet (eg: www.twitch.tv). In one embodiment, the recipient cannot have food delivery purchased for them if they are not live-streaming, so as to prevent a delivery being sent when they are not available to receive it. In a second embodiment, the recipient may not need to be live-streaming to receive a delivery.

It is called a “Treat” when someone receives or sends food delivery through our system and method. It should be understood that “Treat” is not a trademarked term, but rather just a word used to describe food delivery being sent to a recipient in the context of our system and method.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 displays the process of a user logging into our system for the first time.

FIG. 2 displays the visible options of attaching a food delivery option for purchase to a user's account.

FIG. 3 shows the options the end-user has over the food delivery option mentioned in FIG. 2.

FIG. 4 shows how the end-user is able to change their delivery address with our system. This delivery address is kept private, and allows other users to purchase food delivery to that location without knowing the delivery address itself.

FIG. 5 displays that the ability to send food delivery to a person is not possible if that person is in the process of changing their delivery address.

FIG. 6 displays what the purchasing a treat looks like from the customer's perspective.

### DETAILED DESCRIPTION OF THE INVENTION

This patent discloses and claims a useful and novel invention for a system and method that allows for submitting food delivery orders for non-self recipients, without having to know or input an actual delivery address. An advantage that adds to the novelty is that the food selected for delivery is chosen by the recipient themself, without having to directly communicate this information with the one who is placing the food delivery order. Another advantage is that the recipient is free to hide any food delivery options on his account, disabling it from being purchased upon their discretion. Another advantage is that the recipient can choose how often food can be purchased for them, ranging from a minimum of every 4 hours, to a maximum of every 72 hours.

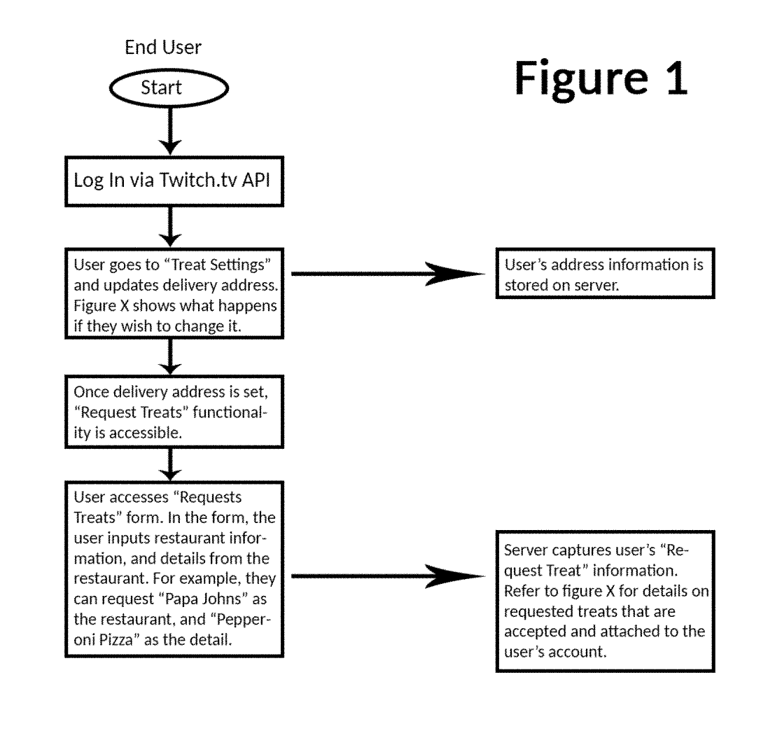

Referring to the drawings included herewith, wherein like numerals indicate like elements throughout, FIG. 1 displays the process of a user logging into our system for the first time. Upon login, they are given the option to set their delivery address. If the user does not have a delivery address set, they cannot use the system to receive a Treat. Once the user sets their delivery address, they are free to send the server detailed requests of what kind of Treats they wish to receive. For example, they can choose a “Pepperoni Pizza” from “Papa Johns”. To do this, the user can install a browser extension, or a phone app.

From the browser extension, the user chooses the restaurant service, and the extension redirects them to the appropriate page for that service. For example, the user can select “Papa Johns” from the extension, and it will redirect them to www.papajohns.com

When the user is on the page, the user adds items to the shopping cart, and the browser extension reads the html coding of the page, and parses the information from the shopping cart. It parses the contents of the cart, total price, delivery minimums, restaurant opening and closing times.

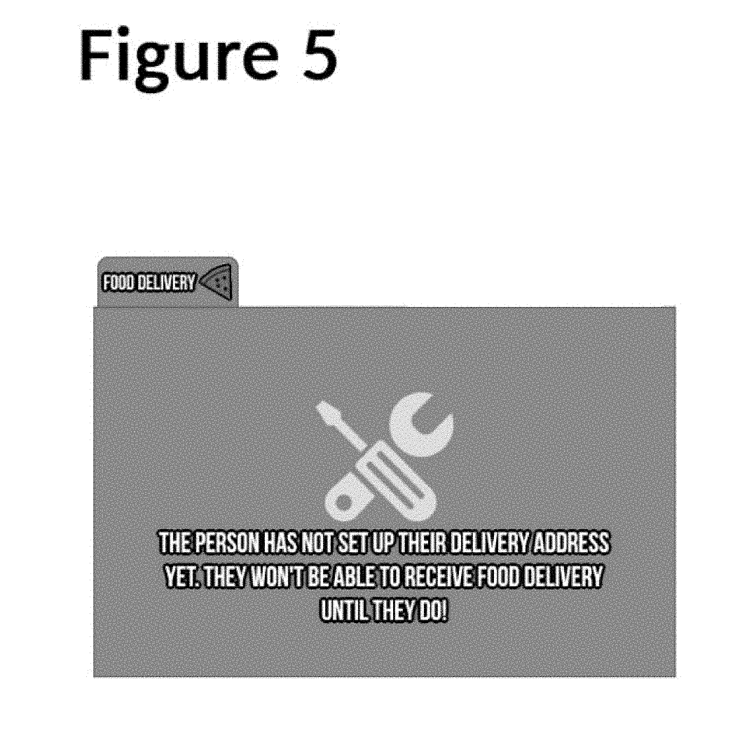

The user is then able to submit this information to the administrator's server, where it automatically creates an item on the user's Treat Donation Page (FIG. 5) by feeding the information in the administrator's database.

If the user is not able to use the extension or phone app, they have the option to manually request the treat from the administrator via e-mail. If an administrator chooses to accept their request, they can attach the requested Treat to the user's account, and set the appropriate price for it.

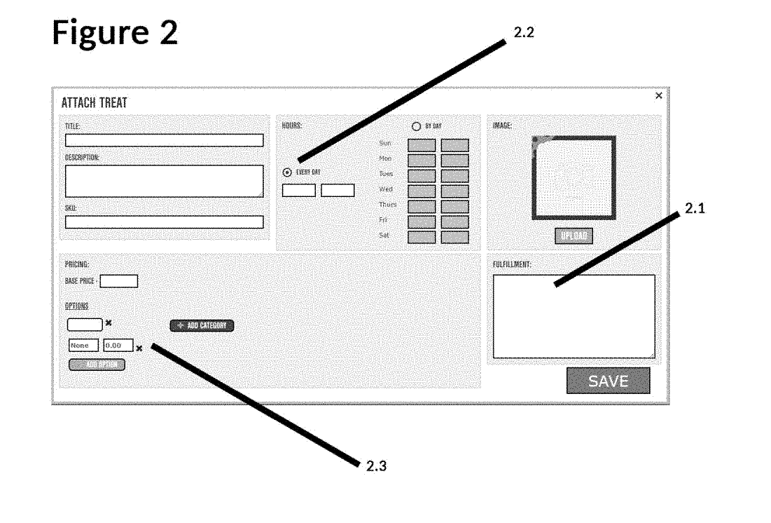

FIG. 2 displays the options of attaching a treat to a user's account. The image displays all the elements required to make a Treat functional on a user's account. A Treat has a title, description, SKU (a name visible only to an administrator), fulfillment, potential side options, price, photo, opening hours, and closing hours.

The fulfillment 2.1 entails the steps needed in order to successfully place the order. It describes the restaurant name and the items from the restaurant that need to be ordered.

The opening and closing hours 2.2 dictate when the Treat is available to be purchased. If the current time is outside of the opening and closing hours' window, the Treat will be locked, and cannot be purchased. The opening and closing hours are relative to the user's set time zone. The user's time zone is set by the user themselves when they update their delivery address.

The side options 2.3 are optional items that can be added to the order, but don't necessarily come with the order by default. These are usually added when the end user requests drinks or appetizers. If selected during the purchase of a treat, they may increase the price of the treat by a set amount.

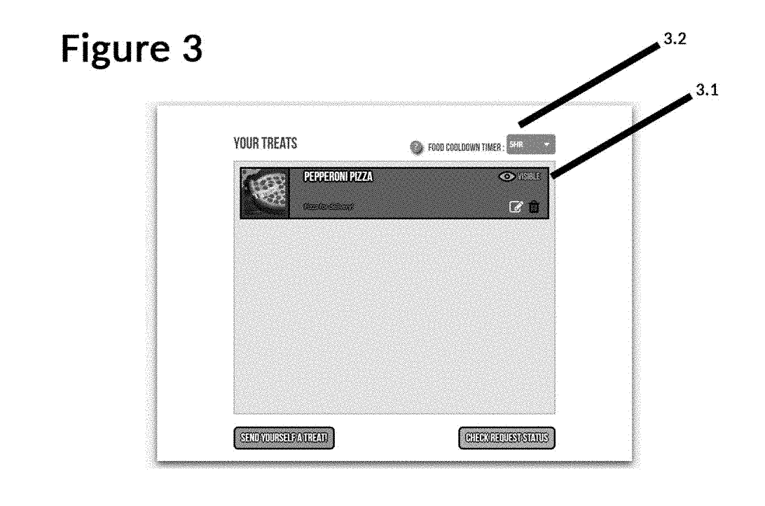

FIG. 3 shows the options the user has over the Treat(s) that have been attached to their account. The user has the ability to alter the description of the treat, and they can alter the photo of the treat. They can also alter the visibility 3.1 of the treat. If the treat is set to not visible, then the treat cannot be purchased for them. This gives the user more control over what they can receive and when, and is very important to the integral process of the invention.

The food cooldown timer 3.2 allows the user to set the frequency of which food can be ordered for them, starting at, for example, a minimum of 4 hours. For example, if the user sets the timer to 10 hours, that means if food was purchased for them, all of their treats will be locked from future purchasing for the next 10 hours. This is also very important to the integral process of the invention.

User's also have the ability to permanently delete the treat. If the user wishes to recover a deleted treat, the only option they have is to send in another request for it.

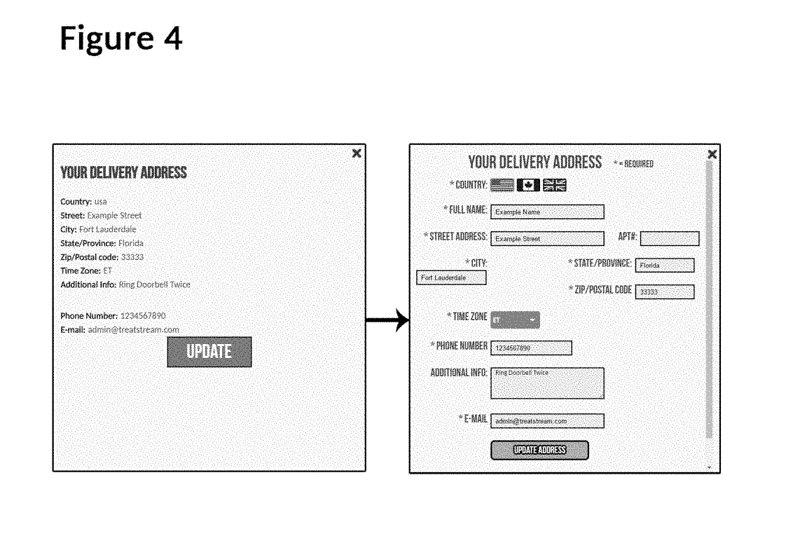

FIG. 4: If the user changes location, they have the option to change their delivery address. If the user sends in a request to change the delivery address, then their treats will be locked from purchase (FIG. 5) until their delivery address is approved by the server.

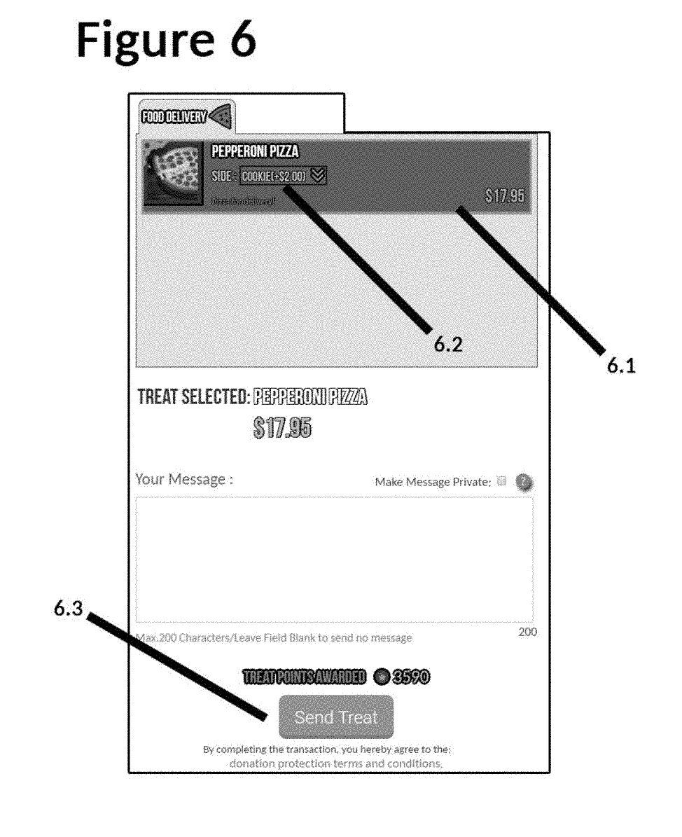

FIG. 6 displays what the purchasing a treat looks like from the customer's perspective when the user who would receive the treat is streaming live on Twitch.tv. The detection of the user's live streaming status is done through Twitch.tv's API. In a first embodiment, if the user is not live streaming, then their treats would be locked from purchase. This is to prevent treats being ordered at a time when the would-be recipient wouldn't be available to receive it. In a second embodiment, the recipient may not need to be live-streaming to receive a delivery

FIG. 6: When the user who would receive the treat activates their account, the customer simply selects the treat 6.1 and any additional side options 6.2 (if present), and simply clicks on the payment button 6.3. The payment button allows the customer to pay for the service via PayPal.

When the payment successfully goes through, the user that receives the treat gets a notification for the order in their e-mail. The food delivery order is then placed via: 1) automated scripts that place the order online, 2) API calls for the correct online delivery service, or 3) manually by employees of the service.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

I claim:

1. A method for confidential food delivery service, comprising:
registering an account with said food delivery service by a user;
associating a user name with said account;
associating a phone number with said account;
associating a delivery address with said account;
associating a time zone with said account;
entering a treat preference with said account;
entering a delivery time with said account;
selecting a delivery cooldown timer for said account;
publishing said treat preference to a public user profile; and
maintaining confidential said phone number and said delivery address.

2. The method of claim 1, further comprising:
viewing said public user profile by a third-party;
selecting of said treat preference by said third-party;
ordering of said treat preference by said third-party;
paying for said treat preference by said third-party to said food delivery service;
ordering of said treat preference by said food delivery service with a local foodservice;
paying for said treat preference by said food delivery service with said local foodservice;
delivering of said treat preference by said local foodservice to said user; and
starting said treat delivery cooldown timer.

3. The method of claim 2,
wherein said third-party does not have access to said phone number and said delivery address.

4. The method of claim 3,
wherein said delivery cooldown timer may be activated by said user.

5. The method of claim 4,
wherein said delivery cooldown timer prevents said ordering of said treat preference by said third-party.

6. The method of claim 5,
wherein said delivery cooldown timer may be de-activated by said user.

7. The method of claim 6,
wherein said treat preference may only be set by said user.

8. The method of claim 7,
wherein said publishing said treat preference to a public user profile may be unpublished by said user.

9. The method of claim 8,
wherein said publishing said treat preference to said public user profile may not be performed when said associating said delivery address with said account has not been performed.

10. The method of claim 9, further comprising,
associating said account with a streaming media profile.

11. The method of claim 10,
wherein said ordering of said treat preference by said third-party may not be performed when said user is not logged in to said streaming media profile.

12. A method for confidential food delivery service, comprising:
registering an account with said food delivery service by a user;
associating a user name with said account;
associating a phone number with said account;
associating a delivery address with said account;
associating a time zone with said account;
entering a treat preference with said account;
entering a delivery time with said account;
publishing said treat preference to a public user profile; and
maintaining confidential said phone number and said delivery address.

13. The method of claim 12, further comprising:
viewing said public user profile by a third-party;
selecting of said treat preference by said third-party;
ordering of said treat preference by said third-party;
paying for said treat preference by said third-party to said food delivery service;
ordering of said treat preference by said food delivery service with a local foodservice;
paying for said treat preference by said food delivery service with said local foodservice; and
delivering of said treat preference by said local foodservice to said user.

14. The method of claim 13,
wherein said third-party does not have access to said phone number and said delivery address.

15. The method of claim 14,
wherein said treat preference may only be set by said user.

16. The method of claim 15,
wherein said publishing said treat preference to a public user profile may be unpublished by said user.

17. The method of claim 16,
wherein said publishing said treat preference to said public user profile may not be performed when said associating said delivery address with said account has not been performed.
